(19) United States
(12) Patent Application Publication
(10) Pub. No.: US 2018/0178769 A1
(43) Pub. Date: Jun. 28, 2018

(54) METHOD FOR ASSISTING DRIVERS IN THE EVENT OF AQUAPLANING ON A ROAD SURFACE

(71) Applicant: Continental Teves AG & Co. oHG, Frankfurt (DE)

(72) Inventors: Thomas Raste, Oberursel (DE); Peter Lauer, Karben (DE); Alfred Eckert, Mainz-Hechtsheim (DE)

(73) Assignee: Continental Teves AG & Co. oHG, Frankfurt (DE)

(21) Appl. No.: 15/882,331

(22) Filed: Jan. 29, 2018

Related U.S. Application Data
(63) Continuation of application No. PCT/EP2016/066524, filed on Jul. 12, 2016.

(30) Foreign Application Priority Data
Jul. 27, 2015 (DE) 10 2015 214 176.4

(51) Int. Cl. B60T 8/1761; B60T 8/1755; B60T 8/172

(52) U.S. Cl. CPC B60T 8/1761; B60T 8/172; B60T 8/1755

(57) ABSTRACT

A method and device for driver assistance in the event of aquaplaning on a road surface on which a vehicle is traveling, wherein a check as regards whether aquaplaning is presently occurring is performed on the basis of at least one driving dynamics variable, and, in the event of aquaplaning being identified, an intervention for a change in direction is performed at a rear-wheel brake, wherein the brake pressure is set in a manner dependent on a driver steering demand.

### CROSS-REFERENCE TO RELATED APPLICATION

This application claims the benefit of International application No. PCT/EP2016/066524, filed Jul. 12, 2016, which claims priority to German patent application No. 10 2015 214 176.4, filed Jul. 27, 2015, each of which is hereby incorporated by reference.

### TECHNICAL FIELD

The invention relates to a method for driver assistance in the event of aquaplaning on a road surface on which a vehicle is traveling, wherein a check as regards whether aquaplaning is presently occurring is performed on the basis of at least one driving dynamics variable. The invention also relates to a device for carrying out a method of said type.

### BACKGROUND

In the event of aquaplaning or hydroplaning, a reduction in the forces that can be transmitted between the respective tire of the vehicle and the road surface occurs. In particular, the lateral guidance forces or transverse forces may decrease. Despite large steering wheel angle inputs, the vehicle performs scarcely any further changes in direction or only limited changes in direction, or performs changes in direction predominantly as a result of disturbances such as for example side wind or roadway inclination. The steering angle set by the driver no longer corresponds to the movement of the vehicle. In the extreme situation, the vehicle becomes unsteerable, and control can quickly be lost.

Modern motor vehicles have driver assistance systems or driver safety systems such as Electronic Stability Control (ESC), which serves for driving dynamics regulation for transverse stabilization, and the anti-lock system ABS and the traction control system (TCS), which serve for longitudinal stabilization, which systems intervene so as to assist the driver in critical situations, with the aim of bringing the vehicle into a stable situation in terms of driving dynamics. For example, in the event of ESC interventions, skidding of the vehicle is prevented by means of targeted braking of the individual wheels.

In the case of known ESC systems, the regulating intervention is limited, in the event of aquaplaning, to engine and braking interventions with the aim of reducing the speed of the vehicle. If both front wheels can no longer transmit transverse forces or lateral guidance forces owing to aquaplaning, it is not possible to steer or set a direction by steering the front wheels.

DE 10 2013 008 943 A1 has disclosed a method for driver assistance in the event of slippery road surfaces, in which method it is identified whether a slippery road surface is present by monitoring the profile with respect to time of an operating variable of a steering system of the vehicle.

### SUMMARY

A method of making a vehicle steerable during the occurrence of aquaplaning is herein described. It is furthermore sought to specify a device for carrying out a method of said type.

In the event of aquaplaning being identified, an intervention for a correction of the direction of travel (change in direction), in order to make control of the direction of the vehicle possible. Accordingly, the intervention is performed through the setting of a brake pressure at a rear-wheel brake, wherein the brake pressure is set in a manner dependent on a driver steering demand.

In the event of aquaplaning during driving, rotations of the steering wheel by the driver scarcely influence, or do not influence at all, the travel of the vehicle. The vehicle travels onward straight ahead, or turns owing to an external disturbance, without the driver being able to actively influence this. In such a situation, the front wheels decelerate significantly, often to a rotational speed of zero, in particular if they are not driven. Driven wheels may also spin. In such situations, the aim of a slip regulator such as TCS is firstly to align the rotational speed of the wheels with the actual vehicle speed, and secondly to estimate as precisely as possible the vehicle speed from the disrupted wheel rotational speed sensor signals of the wheel speeds. For safety reasons, it would however be desirable for the vehicle to remain controllable or steerable even in the presence of aquaplaning. For the reasons stated above, however, this cannot be realized by means of the front wheels.

As has now been identified, in such a situation, steering or a change in direction of the vehicle remains possible by means of the rear wheels, because the rear wheels, which run in the track of the front wheels which have already at least partially displaced the water, can still transmit force to the road. Here, the vehicle can be steered by means of targeted braking interventions at the rear-wheel brakes.

In the event of aquaplaning at both sides (both front wheels exhibit aquaplaning characteristics), it is preferable for a targeted intervention for a change in direction to be performed.

A build-up of a braking torque at the right-hand rear wheel generates a rotation of the vehicle to the right, correspondingly to a rotation of the steering wheel clockwise. A build-up of a braking torque at the left-hand rear wheel generates a rotation of the vehicle to the left, correspondingly to a rotation of the steering wheel counterclockwise. It is therefore the case that, in the presence of a driver steering demand to the left, a brake pressure is set, or a braking torque is built up, at the left-hand rear-wheel brake, and in the presence of a driver steering demand to the right, a brake pressure is set, or a braking torque is built up, at the right-hand rear-wheel brake. The application of the corresponding braking torque then leads to a turn-in of the vehicle, whereby the vehicle can be steered.

The driver steering demand can be determined on the basis of the set steering wheel angle. Here, the present speed of the vehicle and/or the steer angle characteristic curve can be taken into consideration. From this, the desired rotation of the vehicle is then calculated, from which a setpoint braking torque, and from this the brake pressure to be set, are calculated. The greater the set steering wheel angle, the greater also is the pressure set at the respective wheel. This may be a proportional characteristic.

In one embodiment, a direction demand is determined from the identification of the driving lane with the aid of an evaluation of a surrounding sensor arrangement, for example a camera. In a further embodiment, both the set steering wheel angle and the direction demand determined from the surroundings sensor arrangement are taken into consideration, for example are proportionately combined.

In another version of the method, both rear wheels are additionally braked. The additional braking superposed for the intervention for correcting the direction of travel is thus performed such that brake pressure is built up in both rear-wheel brakes, wherein a brake pressure difference is set between the right-hand and left-hand rear-wheel brakes. The brake pressure difference gives rise to a turning moment, and as a result a turn-in of the vehicle, for the correction of the direction of travel. The brake pressure difference is calculated from the desired rotation of the vehicle. The calculation may be performed analogously to the calculation described for a single braked wheel.

Additional braking of both rear wheels may be performed only if the force transmission potential of the rear wheels is sufficient (low longitudinal slip).

In an another embodiment of the invention, the intervention for the change in direction is performed by means of a dissipation of brake pressure at one of the rear wheels, if brake pressure is already present in the rear-wheel brakes owing to a brake actuation by the driver. A dissipation of the brake pressure at the left-hand rear wheel generates a rotation of the vehicle to the right, correspondingly to a rotation of the steering wheel clockwise. A dissipation of the brake pressure at the right-hand rear wheel generates a rotation of the vehicle to the left, correspondingly to a rotation of the steering wheel counter-clockwise.

In a another embodiment, the slip of the rear wheels is monitored during the execution of the method. If the slip or the magnitude of the slip of a braked rear wheel exceeds a defined threshold value, the pressure build-up is limited or reduced in order to avoid locking of the rear wheels. Slip regulation may be performed in accordance with known ABS regulation methods.

Aquaplaning can be considered to be identified if the slip of at least one front wheel and/or the slip averaged across both front wheels lies outside a predefined range. Aquaplaning at both sides is considered to be identified if the slip of both front wheels lies outside a predefined range. This may be performed by comparing the magnitude with a threshold value, or a negative and/or positive threshold value may be defined.

In vehicles with rear-wheel drive, in the event of aquaplaning, a high level of brake slip occurs at both front wheels owing to the wave resistance of the water. In vehicles with front-wheel drive, severe drive slip can arise if the driver continues to press the accelerator pedal.

Aquaplaning can also considered to be identified if one front wheel exhibits a high level of brake slip and the other wheel exhibits a high level of drive slip. This is identified if positive slip above a predefined threshold value is identified at one front wheel, and negative slip below a predefined threshold value is identified at the other front wheel.

The driving dynamics variable comprises the signal of at least one wheel rotational speed sensor. In particular, a comparison of the signals of the wheel rotational speed sensors assigned to the front wheels with those of the wheel rotational speed sensors assigned to the rear wheels permits the determination of the slip of the front wheels.

In the case of a vehicle with rear-wheel steering, the rear-wheel steering is deactivated in the event of aquaplaning being identified. In the case of a vehicle in which an active rear-wheel steering system is installed, it is typically the case in normal driving operation that, at a vehicle speed of greater than 80 km/h, the rear wheels are turned in the same direction as the front wheels. This normally has the effect that, with increasing speed, the steering becomes more indirect for the driver, and the vehicle reacts more slowly and can thus be controlled more precisely. For similar steering wheel deflections, the cornering radius becomes greater in the higher speed range.

In the presence of aquaplaning, if the front wheels can build up no or very little transverse force and thus do not contribute to the steering of the vehicle, this can have adverse consequences for the direction of travel. If steering is performed only by the rear wheels, the vehicle thereupon turns in the wrong direction. For example, the driver steers to the right, and the vehicle travels to the left. Consequently, in the event of aquaplaning being detected, the rear wheels must not in any situation be steered in this direction. For this purpose, in the first variant, the rear-wheel steering is deactivated, and the rear wheels are placed into a straight-ahead alignment (the wheel steer angle at the rear axle is permanently set to zero in the event of aquaplaning being identified). Then, the intervention for the change in direction can be performed by means of the targeted braking interventions.

As an alternative to this, in the case of a vehicle with rear-wheel steering, the rear-wheel steering is actuated instead of the braking intervention, and the rear wheels are set in the opposite direction in relation to the steering direction. In this case, the intervention for the change in direction comprises the setting of the steering; beyond this, it is the case that no different brake pressures are set at the rear wheels.

In a another embodiment, in the event of aquaplaning being identified, the wheel steer angle of the front wheels is limited to a predefined threshold value, e.g. to 2° to 3°. This may be performed in terms of magnitude, that is to say the same threshold values predefined to both sides.

Here, it is the case that, during the corrective intervention, an opposing moment is set at the steering wheel. The steering is thereby, in effect, made heavier. The opposing moment amounts to approximately 2 to 3 Nm.

Therefore, in the event of aquaplaning being identified, directional control of the vehicle is made possible by means of targeted braking interventions at the rear-wheel brakes, whereby accidents and hazardous situations can be prevented.

By means of a limitation of the wheel steer angle at the front wheels, a situation is prevented in which the vehicle is caused to skid when adhesion at the front wheels is regained in the presence of a large steering input. An excessive steering input by the driver is prevented by virtue of the steering being stiffened.

### BRIEF DESCRIPTION OF THE DRAWINGS

An exemplary embodiment of the invention will be discussed in more detail on the basis of drawings. In the drawings, in a highly schematic illustration:

FIG. 1 shows a flow diagram of a method for driver assistance in the event of aquaplaning on a road surface in a exemplary embodiment; and

FIG. 2 shows a device for carrying out a method for driver assistance in a embodiment; and

FIG. 3 shows a motor vehicle with the acting forces.

### DETAILED DESCRIPTION

In all of the figures, identical parts are denoted by the same reference designations.

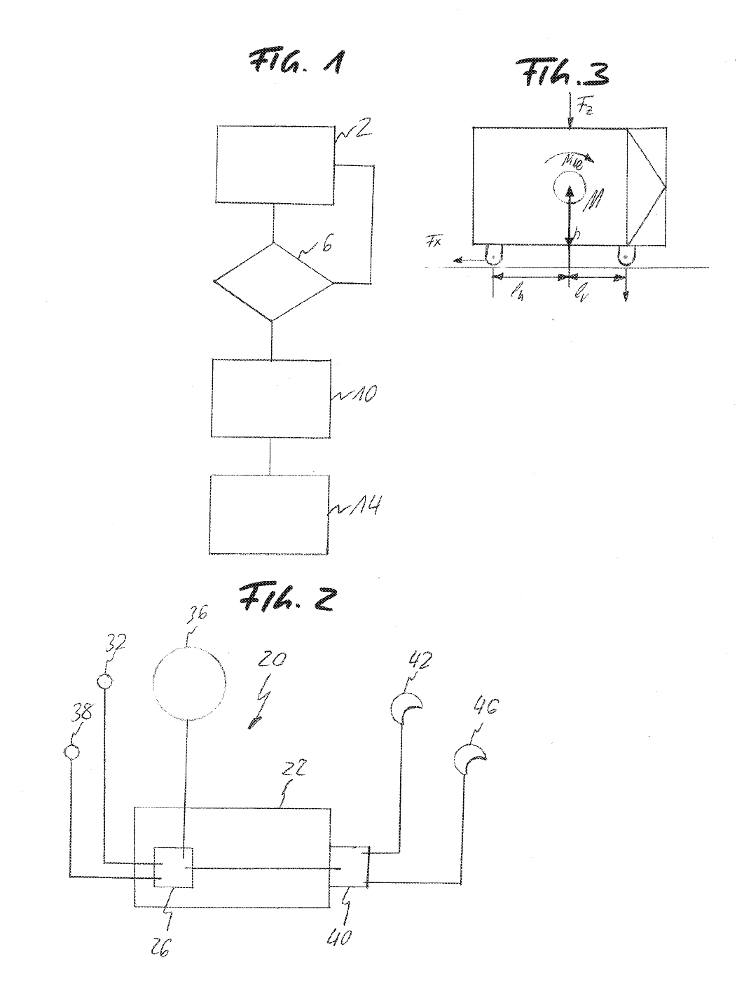

In an exemplary embodiment of a method for driver assistance in the presence of aquaplaning, as illustrated in FIG. 1 in the form of a flow diagram, a check as regards whether aquaplaning is presently occuring is performed in a block 2. For this purpose, the signals from wheel rotational speed sensors at the front wheels are checked. If said signals indicate intense slip, in particular negative slip in the case of rear-wheel-drive vehicles and positive slip in the case of front-wheel-drive vehicles, that is to say if the respective magnitude of the slip of both front wheels exceeds a predefined threshold value in the absence of braking, aquaplaning is considered to be identified. In both cases, the occurring slip generates a clearly measurable change in acceleration, and a considerable deceleration of the vehicle as a result of the acting wave resistance of the water.

The presence of severe slip has the effect that lateral guidance forces or transverse forces, by means of which a direction of the vehicle can be set, can be transmitted only to a small extent, or not at all, between the front wheels and the road. The vehicle becomes unsteerable and thus uncontrollable.

It is the aim of the present invention, in such situations, to permit braking-assisted directional control, and, in association therewith, to enable the driver to control the vehicle. In a decision block 6, the method branches differently depending on whether or not the presence of aquaplaning has been identified in block 2. If no aquaplaning has been identified, the method branches back to block 2, in which a check is performed again with regard to the presence of aquaplaning.

Otherwise, in a block 10, the driver steering demand is determined by means of the steering wheel angle set by the driver. Proceeding from this, a setpoint braking torque, which is to be set at one of the two rear-wheel brakes, is determined. The setpoint braking torque is converted into the brake pressure to be built up at the corresponding brake.

In a block 14, a corrective intervention is then performed, which in the present case is a braking intervention. In the presence of a steering deflection to the right, it is the case here that a braking torque is built up at the right-hand rear-wheel brake, such that the vehicle turns in to the right. In the presence of a steering deflection to the left, a braking torque is built up at the left-hand rear-wheel brake, such that the vehicle turns in to the left. The vehicle can be steered by means of these targeted braking interventions. The maximum magnitude of applied brake pressure in the respective rear-wheel brake may amount to 10 to 20 bar. By means of a limitation of the applied brake pressure, the likelihood of locking of the rear wheels is reduced.

In the event that not only the steering demand but also a braking demand from the driver is detected, a brake pressure difference is correspondingly set at the two rear-wheel brakes, such that braking of the vehicle and the desired turn-in are performed simultaneously. In any case, in the event of aquaplaning being identified at one side or at both sides, the potential of the rear wheels is utilized to decelerate the vehicle if it is in a critical speed range, e.g. faster than 60 km/h.

With the deceleration caused by the braking, a turning moment is generated about the pitch axis, which generates an additional force Fz in the direction of the normal force (F_{N}) at the front wheels, see for example FIG. 3. In the example shown there, the additional force Fz is calculated, with:

braking force Fₓ=1000 N

height of the center of gravity h=0.5 m

distance between front axle and center of gravity 1ᵥ=1.1 m

distance between rear axle and center of gravity 1ₕ=1.3 m

normal force in the absence of braking F_{N}=4000 N,

$${F}_{Z} = \frac{h}{{l}_{h} + {l}_{v}} {F}_{X} = \frac{0.5}{2.4} 1000 N = 208 N$$

as 208 N per wheel, in addition to the normal force in the absence of braking of 4000 N. This thus yields an overall force of 4208 N per front wheel during braking. This increase applies to both front wheels. Therefore, an improved displacement of the water film, and thus improved grip of the front wheels, and thus an improved steering capability of the vehicle, are ensured.

FIG. 2 schematically illustrates a device 20 for carrying out a method as described above. The device 20 comprises a driving dynamics regulator 22 with a control and regulation unit 26, in which the method is implemented in the form of software and/or hardware. The method is realized as a computer program which is loaded into a memory of the control and regulation unit 26.

The control and regulation unit 26 is connected at the signal input side to wheel rotational speed sensors 32, 38, which are assigned to the two front wheels, and to a steer angle sensor 36. Said control and regulation unit is connected at the signal output side to a pressure provision device 40, which, in accordance with demand, builds up pressure in a rear-wheel brake 42, which is assigned to the left-hand rear wheel, or in a rear-wheel brake 46, which is assigned to the right-hand rear wheel.

If, on the basis of the signals from the wheel rotational speed sensors 32, 38, the control and regulation unit 26 identifies severe slip, aquaplaning is considered to be identified. By means of the steering wheel angle which it receives from the steer angle sensor 36, said control and regulation unit calculates a setpoint braking torque, which is built up in the left-hand and/or right-hand rear-wheel brake 42, 46. The setpoint braking torque is then converted into a brake pressure 42, 46 to be built up in the corresponding rear-wheel brake. The control and regulation unit 26 controls the pressure provision device 40, which may be also used for the service braking functionality, in order to set said brake pressure.

The corrective intervention of the control and regulation unit 26 performed in this way is ended as soon as it is identified that the front wheels can transmit transverse forces again, and the driver can again control the vehicle by means of the steering system.

A vehicle model, for example the linear singletrack model, is stored in the control and regulation unit 26. The vehicle speed vector v is determined by means of a camera or an optical sensor and/or other sensors, and the side slip angle β is determined by means of the vehicle model, such that the angular position of the front wheels (wheel steer angle) can be determined in relation to the vehicle speed vector.

If the steer input angle (wheel steer angle) of the front wheels exceeds, in terms of magnitude, a predefined positive threshold value, which may be 2° to 3°, the steering is stiffened, which is realized through the build-up of an opposing moment at the EPS (Electronic Power Steering). The reasons for this are as follows. If, in the presence of aquaplaning, the driver no longer senses a reaction of the vehicle to his or her control signals by means of the steering wheel or steering movements, because the vehicle is not following his or her steering demand, the driver typically steers to an excessive degree, or generates an excessive steering input. This must be prevented, because the driver must not encounter a road surface with a high friction coefficient when the wheels are turned in to a large degree or are in a transverse position. In this situation, the vehicle would have such an intense rotary impetus imparted to it that the ESP would no longer be capable of preventing skidding of the vehicle.

In a another embodiment of the invention, the front wheels are aligned in the direction of the traveling speed vector v. An opposing moment may be set at the steering wheel such that the alignment of the front wheels is as close as possible to the direction of the traveling speed vector v. This measure serves to prevent a sudden change in direction of the vehicle as soon as it encounters a high friction coefficient. For this purpose, the determination of the sideslip angle of the vehicle is necessary. The opposing moment may be set such that the alignment of the front wheels deviates from the direction of the traveling speed vector by less than a predefined threshold value.

1. A method for driver assistance in the event of aquaplaning on a road surface on which a vehicle is traveling comprising:
checking on the basis of at least one driving dynamics variable whether the vehicle is presently aquaplaning;
intervening for a change in direction in the event of aquaplaning is identified and
wherein the intervening is performed at at least one, rear-wheel brake, wherein the brake pressure at the at least one rear-wheel brake is set in a manner dependent on a driver steering demand.

2. The method as claimed in claim 1, further comprising building the brake pressure at the left-hand rear-wheel brake in the presence of a driver steering demand to the left, and building the brake pressure at the right-hand rear-wheel brake in the presence of a driver steering demand to the right.

3. The method as claimed in claim 1, further comprising depleting the brake pressure at the right-hand rear-wheel brake in the presence of a driver steering demand to the left, and depleting the brake pressure at the left-hand rear-wheel brake in the presence of a driver steering demand to the right.

4. The method as claimed in claim 1, further comprising determining the driver steering demand with the aid of one of:
the steering wheel angle set by the driver and the aid of a surroundings sensor arrangement.

5. The method as claimed in claim 4, further comprising calculating the brake pressure to be set from the steering wheel angle.

6. The method as claimed in claim 5, wherein the brake pressure to be set is calculated proportionally to the set steering wheel angle.

7. The method as claimed in claim 1, further comprising superimposing on the braking of the vehicle for the intervention for the change in direction an additional braking intervention at both rear wheels.

8. The method as claimed in claim 1, wherein aquaplaning is considered to be identified if the slip of at least one of:
at least one front wheel and the slip averaged across both front wheels lies outside a predefined range.

9. The method as claimed in claim 1, wherein the intervention is performed when aquaplaning is identified at both sides,

10. The method as claimed in claim 9, wherein the intervention is performed when the slip of both front wheels lies outside a predefined range.

11. The method as claimed one of claim 1, wherein the driving dynamics variable comprises the signal from at least one wheel rotational speed sensor.

12. The method as claimed in claim 1, further comprising deactivating rear-wheel steering for a vehicle with rear-wheel steering in the event of aquaplaning is identified.

13. The method as claimed in claim 1, further comprising activating rear-wheel steering for a vehicle with rear-wheel steering in the event of aquaplaning is identified, and wherein a wheel setting angle of the rear wheels is set toward the opposite side in relation to the driver steering demand.

14. The method as claimed in claim 1, further comprising limiting the wheel setting angle of the front wheels to a predefined limit value in the event of aquaplaning is identified.

15. The method as claimed in claim 14, further comprising setting an opposing moment in relation to the driver steering moment at the steering wheel by an active steering force assistance in the event of aquaplaning is identified.

16. The method as claimed in claim 15, wherein the opposing moment is set such that the deviation of the alignment of the front wheels from the direction of travel amounts to less than a predefined threshold value.

17. A device for assisting the driver in the event of aquaplaning comprising:
a driving dynamics regulator with a control and regulation unit with instructions for carrying out:
checking on the basis of at least one driving dynamics variable whether the vehicle is presently aquaplaning;
intervening for a change in direction in the event of aquaplaning is identified; and
wherein the intervening is performed at at least one, rear-wheel brake, wherein the brake pressure at the at least one rear-wheel brake is set in a manner dependent on a driver steering demand.

18. The device as claimed in claim 17, further comprising:
in the presence of a driver steering demand to the left, the brake pressure is one of built up at the left-hand rear-wheel brake and depleted at the right-hand rear-wheel brake and
in the presence of a driver steering demand to the right, the brake pressure is one of built up at the right-hand rear-wheel brake and depleted at the left-hand rear-wheel brake.

18. The device as claimed in claim 17, wherein the driver steering demand is determined with the aid of one of: the steering wheel angle set by the driver and the aid of a surroundings sensor arrangement.

19. The device as claimed in claim 17, wherein the brake pressure to be set is calculated from the steering wheel angle.

20. The device as claimed in claim 17, wherein the intervention for the change in direction has superposed thereon an additional braking intervention at both rear wheels for the braking of the vehicle.

21. The device as claimed in claim 17, wherein aquaplaning is considered to be identified if the slip of at least one of: at least one front wheel and the slip averaged across both front wheels lies outside a predefined range.
